(19) United States
(12) Patent Application Publication
(10) Pub. No.: US 2020/0074513 A1
(43) Pub. Date: Mar. 5, 2020

(54) AUTOMATED PROPERTY VALUE GENERATION

(71) Applicant: Joseph Alongi, Campbell, CA (US)

(72) Inventor: Joseph Alongi, Campbell, CA (US)

(21) Appl. No.: 16/116,082

(22) Filed: Aug. 29, 2018

(51) Int. Cl. G06Q 30/02; G06Q 50/16; G06Q 10/00; G06K 9/32; G06F 17/30; G06F 15/18

(52) U.S. Cl. CPC G06Q 30/0278; G06Q 50/16; G06F 15/18; G06K 9/3241; G06F 17/30247; G06Q 10/20

(57) ABSTRACT

Automated generation of a property value includes receiving, from a user, a property address for a subject property and digital photographs of the subject property. A database property is accessed for property information and property sale information. The property information and the property sale information are used to calculate an estimated property value for the subject property based on comparable properties. This includes determining differences in comparable properties that result in adjustments of estimated property value for the subject property based on differences from the comparable properties. Information from the digital photographs about a condition of the subject property is extracted and used to produce recommendations for repairs and upgrades that will bring a positive user return upon investment. The user is provided with the recommendations for repairs and upgrades that will bring a positive user return upon investment.

### BACKGROUND

Online real estate companies provide innovate ways that sellers can market and buyers can purchase properties. Some companies provide an online real estate marketplace where consumers can acquire data and knowledge about real estate and find real estate professionals to aid in the sale and purchase of properties. The information provide often includes an estimate of current property value.

### BRIEF DESCRIPTION OF THE DRAWINGS

FIG. 1 is a simplified block diagram that includes hardware and software components of an automated real estate system that provides automated housing value generation in accordance with an implementation.

FIG. 2 is a simplified flow chart illustrating automated housing value generation in accordance with an implementation.

FIG. 3 and FIG. 4 illustrates an interface used in automated housing value generation in accordance with an implementation.

FIG. 5A, FIG. 5B, FIG. 5C, FIG. 5D, FIG. 5E and FIG. 5F illustrate results of automated housing value generation being presented to a user in accordance with an implementation.

### DETAILED DESCRIPTION

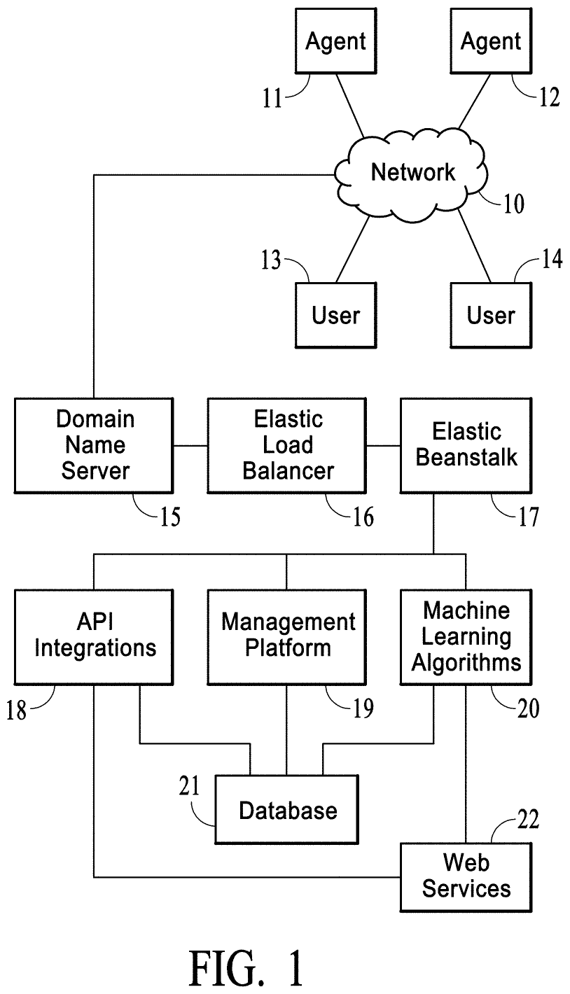

FIG. 1 is a simplified block diagram that includes hardware and software components of an automated real estate system that provides automated housing value generation. A domain name server (DNS) 15 is connected through a network 10 to users and agents. In FIG. 1, user 13 and user 14 represent users while again 11 and agent 12 represent agents. users, represented by a user 13 and a user 14.

An elastic load balancer 16 can be used to balance incoming application traffic across multiple servers and multiple geo location regions. An elastic beanstock 16 or similar technology may be used to perform application health monitoring, capacity provisioning and to deploy and scale web applications and services. For example, elastic beanstock 17 can be used for a Linux CentOS computing platform, an NGINX proxy server, a Node cross-platform runtime environment and an Express web framework and other compatible applications.

Application programming interface (API) integrations 18 can include, for example, SendGrid e-mail delivery service, Twilio cloud communications platform and/or other API integrations services. A management platform 19 can be implemented using VueJS progressive web apps (PWA), Sassy cascading style sheets and a webpack module bundler and/or other similar technology. API integrations 18 allows access of a database that includes property information and property sale information that can be used to calculate property values based on comparable properties and differences in comparable properties that result in adjustments of property values calculated using comparable properties.

Machine learning algorithms 20 can be implemented using an API gateway, Amazon Web Services (AWS) Lambda computer platform, the Python programming language and other similar technology. A database 21 can be implemented, for example, using a Firebase NoSQL database or other similar database. Web services 22 can be implemented using the Slipstream API suite of web services.

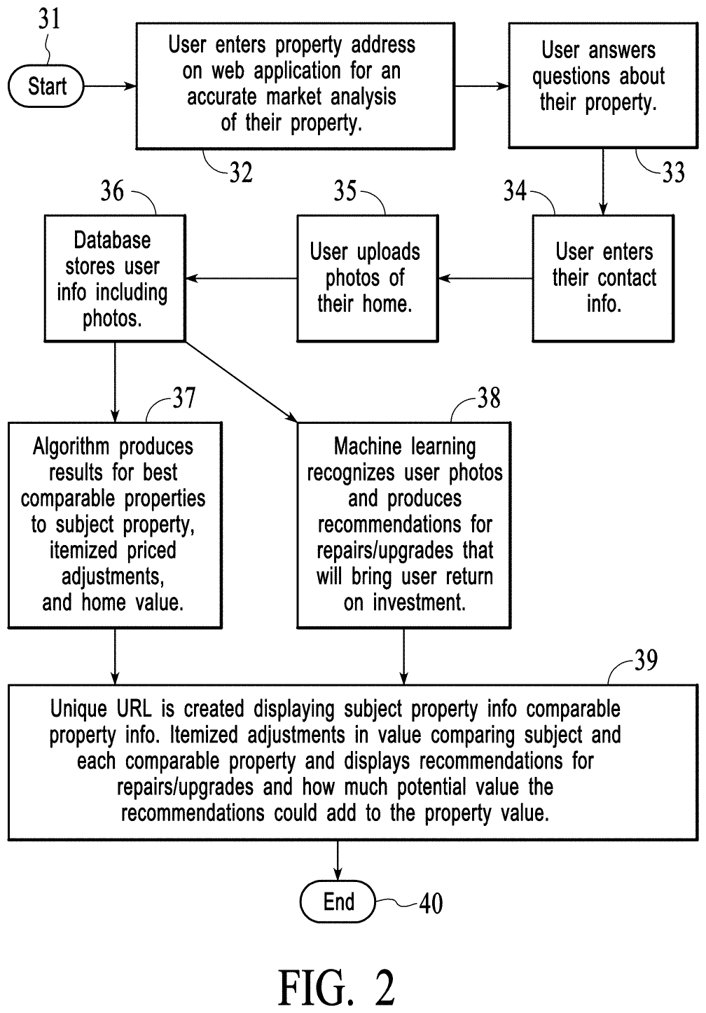

FIG. 2 is a simplified flow chart illustrating automated housing value generation. The process is started in a start block 31. In a block 32, a user enters a property address and requests an accurate market analysis of a subject property at the entered address

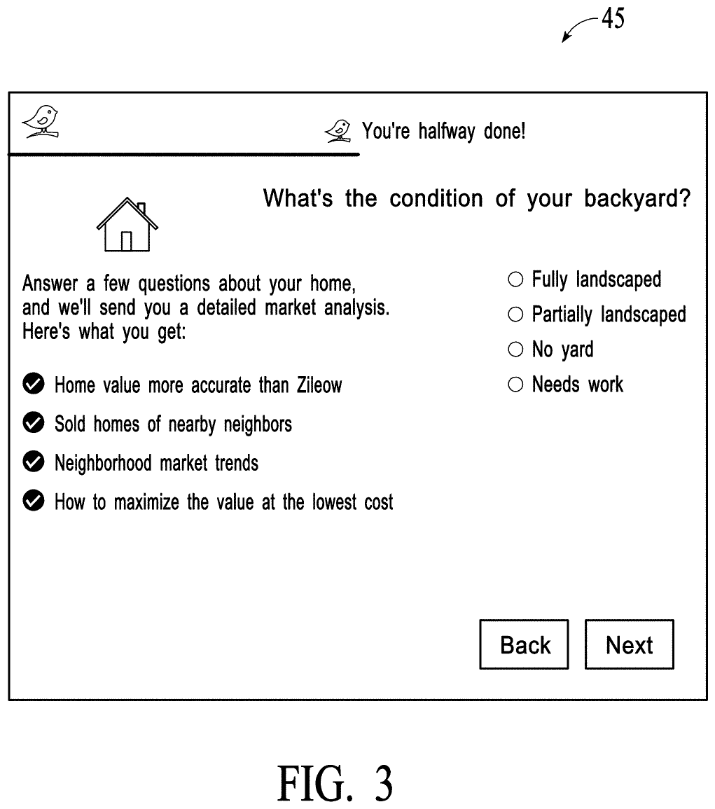

In a block 33, the user answers questions about the subject property. For example, FIG. 3 shows an example interface display 45 where a user provides information about condition of backyard of the subject property. In other interface displays the user can be asked questions about flooring, wall covering, kitchens, bathrooms, laundry rooms, garages, porches and so on.

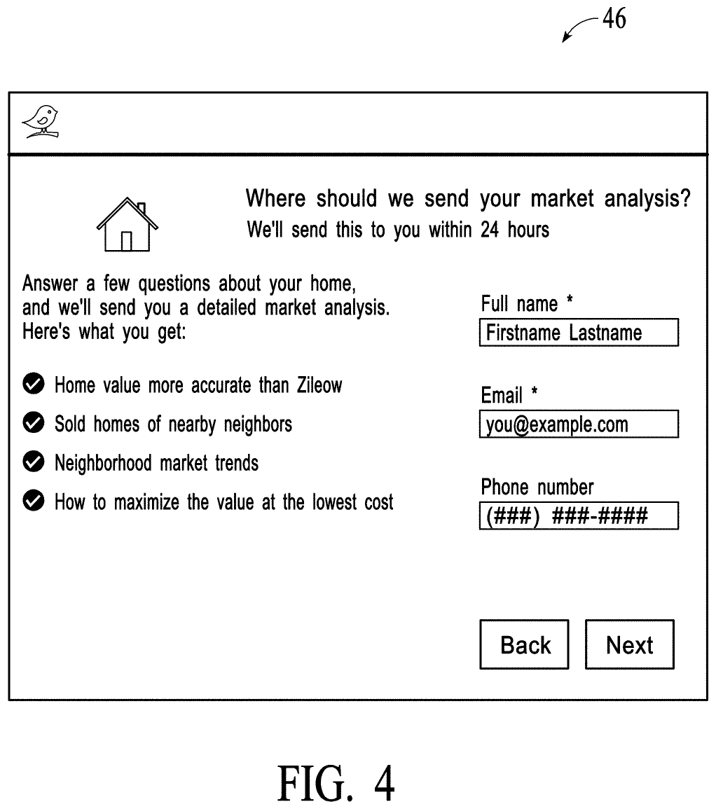

In a block 34, shown in FIG. 2, the user enters contact information. For example, FIG. 4 shows an interface display 46 where a user provides a name and other contact information.

In a block 35, shown in FIG. 2, the user uploads photos of the property. The photos can show bedrooms, kitchens, bathrooms, laundry rooms, garages, flooring, wall covering, home exterior, porches and so on.

In a block 36, database 21 (shown in FIG. 1) stores all the information provided by the user, including the uploaded photos.

In a block 37, algorithms within API integrations 18 (shown in FIG. 1), calculates a property value based on comparable properties and taking into account itemized priced adjustments based on the user information provided by the user in block 33.

In a block 38, machine learning algorithms 20 (shown in FIG. 1), analyzes the photos uploaded in block 36. Machine learning algorithms 20 extracts information about the condition of the subject property from the photos and uses the information extracted from the photos along with the user information provided by the user in block 33 to produce recommendations for repairs and upgrades that will bring a user return upon the investment.

To analyze photos, machine learning algorithms 20 uses deep learning to produce image understanding. For example, machine learning algorithms 20 include convolutional neural networks. Each image to be recognized passes through a series of convolution layers. Convolution and pooling are used for feature learning. The results are classified using flattening, fully connected layers and a softmax function. The softmax function squashes the outputs of each unit to be between 0 and 1, similar to a sigmoid function. The softmax function also divides each output such that the total sum of the outputs is equal to 1. The output of the softmax function is equivalent to a categorical probability distribution: it gives the probability that any of the classes are true.

For example, machine learning algorithms 20 analyzes photos that show flooring to determine materials and conditions of flooring. For example, machine learning algorithms 20 determines whether flooring is composed of carpet, wood, wood composite, tile, linoleum or some other material. For example, machine learning algorithms 20 also determines condition of flooring by evaluating consistency, etc.

For example, machine learning algorithms 20 analyzes photos of cabinetry in a kitchen, bathroom or laundry room to determine materials and conditions of the cabinetry. For example, machine learning algorithms 20 determines whether cabinetry is composed of painted wood, oak, maple, metal, birch, or some other material. For example, machine learning algorithms 20 also determines condition and style of cabinetry by evaluating consistency, etc.

For example, machine learning algorithms 20 analyzes photos of countertops in a kitchen, bathroom or laundry room to determine materials and conditions of the cabinetry. For example, machine learning algorithms 20 determines whether countertops are composed of granite, quartz, laminate, concrete, recycle glass, butcherblock, marble, tile, lava, resin, reclaimed wood, porcelain or some other material. For example, machine learning algorithms 20 also determines condition and style of countertops by evaluating consistency, etc.

For example, machine learning algorithms 20 analyzes photos of cabinet hardware in a kitchen, bathroom or laundry room to determine materials, style and conditions of the cabinet hardware.

For example, machine learning algorithms 20 analyzes photos of doors throughout a home and garage to determine materials, style and conditions of the doors. And so on.

Once the deep learning has been utilized to detect current materials, styles and conditions of materials for flooring, countertops, cabinets and so on, a database is accessed to determine, for the geographic location, for the price range of property and son on, how repairs or upgrades (i.e., changes in materials/styles/conditions) will affect the value of the property. The database also includes estimated costs for each repair or upgrade. For any possible change or upgrade, when the improvement in value of the property exceeds the cost to make the improvement by a predetermined threshold, a recommendation for repair or upgrade is made.

In a block 39, a unique uniform resource locator (URL) is created to display information about the subject property including comparable properties with itemized adjustments in value between the subject property and each comparable property. Also displayed are recommendations for repairs and/or upgrades based on the recommendations produced in block 38. The recommendations for repairs and/or upgrades include, for example, estimates on how much increase in potential value of the subject property would result from the recommended repairs and/or upgrades. In a block 40, the process is complete.

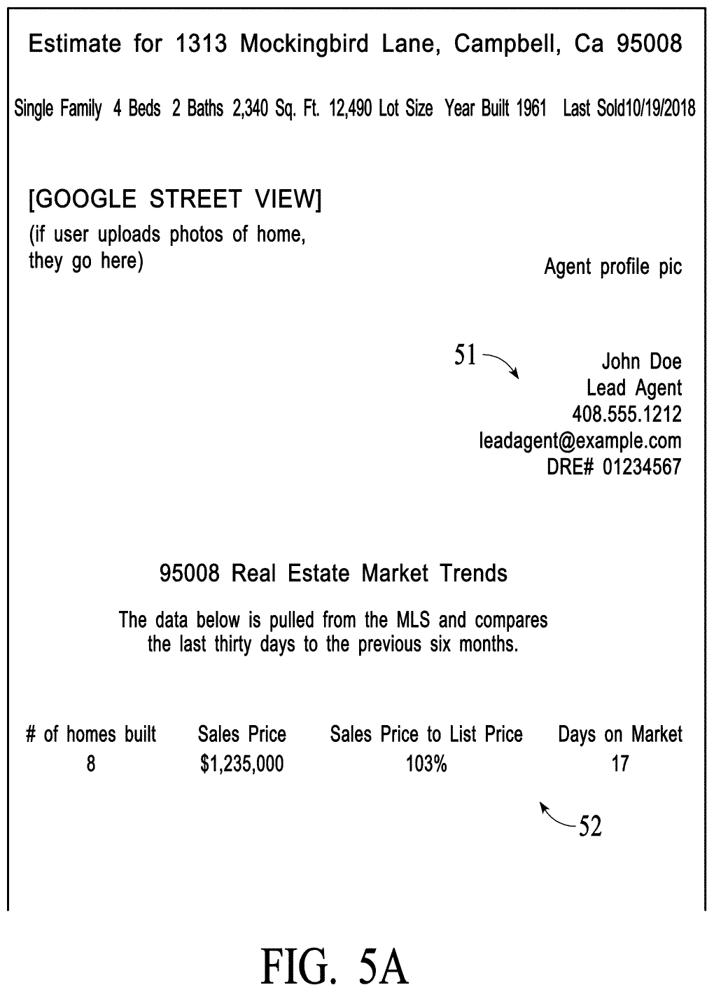

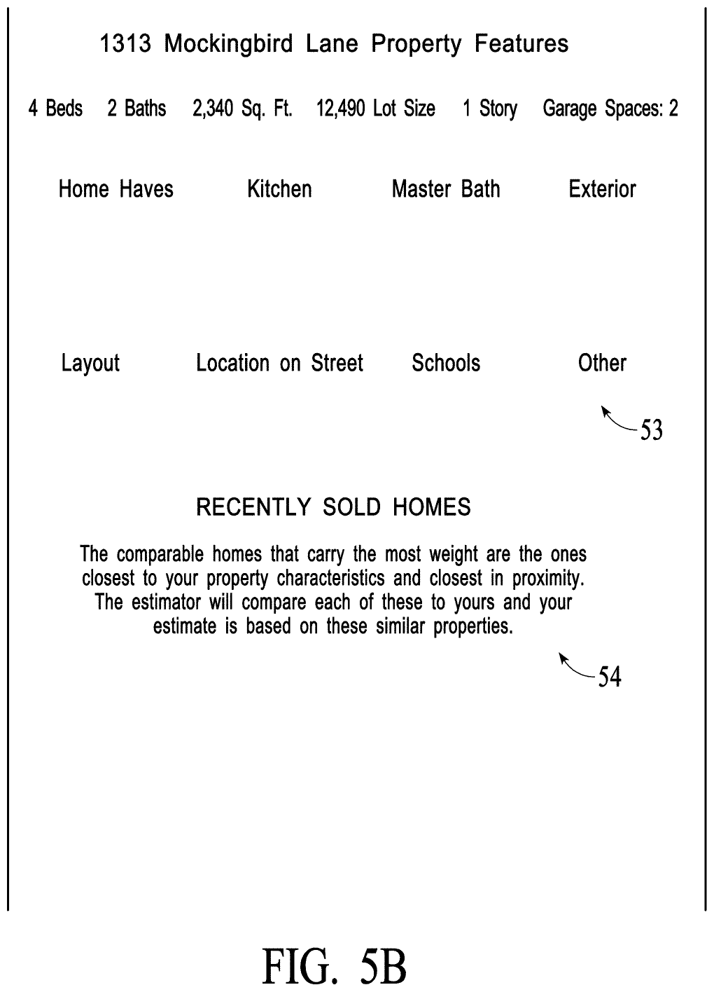

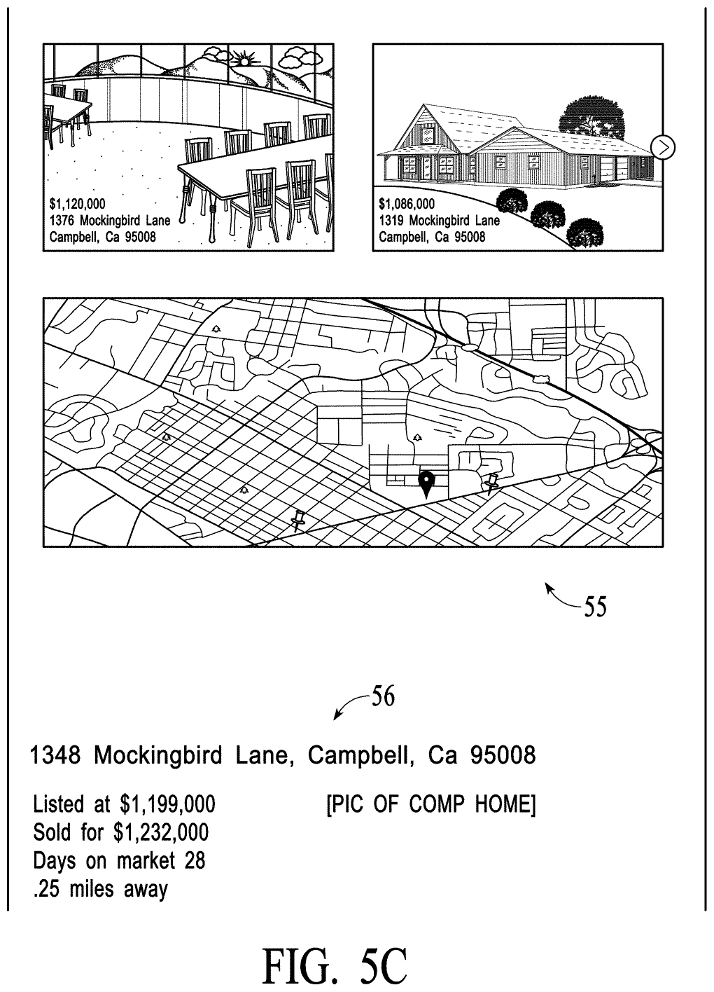

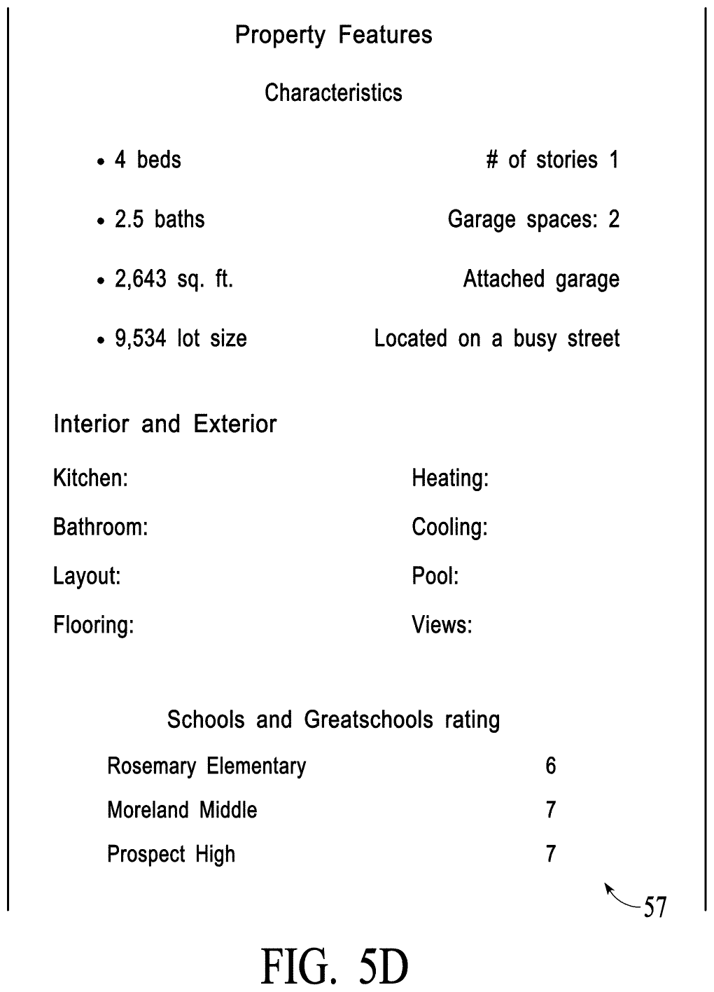

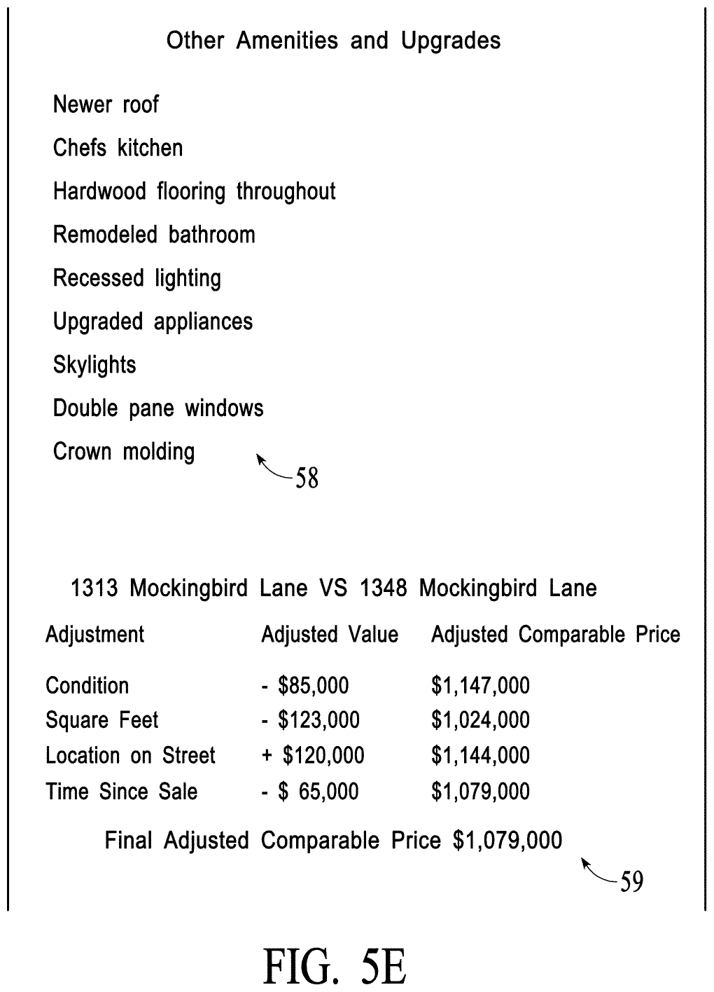

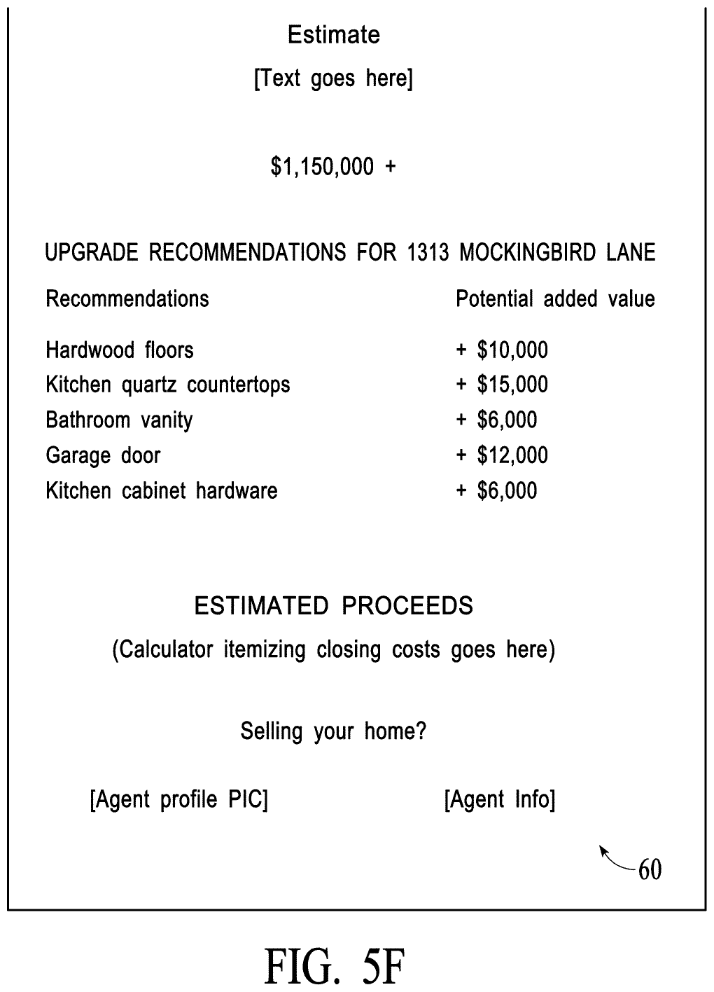

FIGS. 5A through 5G illustrates results of automated housing value generation being presented to a user in accordance with an implementation. The results can be provided on a single web page, or multiple web pages. In FIG. 5A, a section 51 provides information about the subject property and information about an associated agent. A section 52 provides information about market trends.

In FIG. 5B, a section 53 provides information about features of the subject property. A section 54 introduces comparable properties.

In FIG. 5C, a section 55 provides mapping and photo information about comparable properties. A section 56 provides information about a specific comparable property. In FIG. 5D, a section 57 provides additional information about the specific comparable property. In FIG. 5E, a section 58 provides additional information about the specific comparable property including other amenities and upgrades. A section 59 shows comparison made between the subject property and the comparable property or properties. The comparison includes adjusted values for such things as condition, square footage, street location and time since sale.

In FIG. 5F, a section 60 displays an estimated value of the subject property as well as upgrade recommendations and a potential added value for each upgrade recommendation.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

1. A method for automated generation of a property value comprising:
receiving from a user a property address for a subject property;
receiving from the user digital photographs of the subject property;
storing the information about the property and the digital photographs of the subject property;
using application programming interface integrations to access from a database property information and property sale information and using the property information and the property sale information to calculate an estimated property value for the subject property based on comparable properties, including determining differences in comparable properties that result in adjustments of estimated property value for the subject property based on differences from the comparable properties;
extracting, by machine learning algorithms, information from the digital photographs about a condition of the subject property and using the information extracted from the digital photographs by the machine learning algorithms to produce recommendations for repairs and upgrades that will bring a positive user return upon investment, wherein a recommendation is made when an improvement in value of the subject property from a repair or upgrade exceeds an estimated cost to make the repair or upgrade by a predetermined threshold; and
providing to the user the recommendations for repairs and upgrades that will bring a positive user return upon investment.

2. A method as in claim 1, wherein the recommendations for repairs and upgrades pertain to at least one of the following:
upgrade to kitchen;
upgrade to bathroom;
upgrade to flooring;
upgrade to garage.

3. A method as in claim 1, wherein providing to the user the recommendations for repairs and upgrades includes displaying to the user on a display the recommendations for repairs and upgrades.

4. A method as in claim 1, additionally comprising:
receiving from the user contact information for the user.

5. A method as in claim 1, wherein extracting information from the digital photographs includes determining whether flooring is composed of carpet, wood, wood composite, tile, linoleum or some other material.

6. A method as in claim 1, wherein extracting information from the digital photographs includes determining whether cabinetry is composed of painted wood, oak, maple, metal, birch, or some other material.

7. A method as in claim 1, wherein extracting information from the digital photographs includes determining whether countertops are composed of granite, quartz, laminate, concrete, recycle glass, butcherblock, marble, tile, lava, resin, reclaimed wood, porcelain or some other material.

8. A method as in claim 1, wherein extracting information from the digital photographs includes determining materials, style and conditions of cabinet hardware.

9. A method as in claim 1, wherein extracting information from the digital photographs includes determining materials, style and conditions of materials, style and conditions of doors.

10. A system that generates a property value comprising:
a user interface that receives from a user a property address and digital photographs of a subject property;
computer storage that stores the information about the subject property and the digital photographs of the subject property;
application programming interface integrations that access from a database property information and property sale information and use the property information and the property sale information to calculate an estimated property value for the subject property based on comparable properties, wherein the application programming interface integrations determine differences in comparable properties that result in adjustments of estimated property value for the subject property based on differences from the comparable properties; and
machine learning algorithms that extract information from the digital photographs about a condition of the subject property and use the information extracted from the digital photographs to produce recommendations for repairs and upgrades that will bring a positive user return upon investment, wherein a recommendation is made when an improvement in value of the subject property from a repair or upgrade exceeds an estimated cost to make the repair or upgrade by a predetermined threshold;
wherein the user interface displays to the user the recommendations for repairs and upgrades that will bring a positive user return upon investment.

11. A system as in claim 10, wherein the recommendations for repairs and upgrades pertain to at least one of the following:
upgrade to kitchen;
upgrade to bathroom;
upgrade to flooring;
upgrade to garage.

12. A system as in claim 10, additionally comprising a display that displays to the user the recommendations for repairs and upgrades.

13. A system as in claim 10, wherein the user interface additionally receives from the user contact information.

14. A system as in claim 10, wherein the machine learning algorithms determine from the digital photographs whether flooring is composed of carpet, wood, wood composite, tile, linoleum or some other material.

15. A system as in claim 10, wherein the machine learning algorithms determine from the digital photographs whether cabinetry is composed of painted wood, oak, maple, metal, birch, or some other material.

16. A system as in claim 10, wherein the machine learning algorithms determine from the digital photographs whether countertops are composed of granite, quartz, laminate, concrete, recycle glass, butcherblock, marble, tile, lava, resin, reclaimed wood, porcelain or some other material.

17. A system as in claim 10, wherein the machine learning algorithms determine from the digital photographs materials, style and conditions of cabinet hardware.

18. A system as in claim 10, wherein the machine learning algorithms determine from the digital photographs materials, style and conditions of materials, style and conditions of doors.

19. A system that generates a property value comprising:
a user interface that receives from a user a property address of a subject property and information about the subject property including condition information about physical condition of the subject property, the condition information including information about current materials, styles and conditions of materials used in the subject property;
computer storage that stores the information about the subject property including the condition information about the physical condition of the subject property; and
application programming interface integrations that access from the database property information and property sale information and use the property information and the property sale information to calculate an estimated property value for the subject property based on comparable properties, wherein the application programming interface integrations determine differences in comparable properties that result in adjustments of estimated property value for the subject property based on differences from the comparable properties, including:
machine learning algorithms that use the condition information about the condition of the subject property to produce recommendations for repairs and upgrades that will bring a positive user return upon investment, wherein a recommendation is made when an improvement in value of the subject property from a repair or upgrade exceeds an estimated cost to make the repair or upgrade by a predetermined threshold;
wherein the user interface displays to the user the recommendations for repairs and upgrades that will bring a positive user return upon investment.

20. A system as in claim 19, wherein the user interface asks the user questions to obtain information about flooring, wall covering, kitchen, bathrooms, laundry room, garage and porches for the subject property.
